(19) United States
(12) Patent Application Publication
(10) Pub. No.: US 2011/0229240 A1
(43) Pub. Date: Sep. 22, 2011

(54) CONNECTION TRANSPORT DEVICE AND IMAGE FORMING DEVICE

(75) Inventor: Ryouta SHIBAYAMA, Okazaki-shi (JP)

(73) Assignee: Konica Minolta Business Technologies, Inc., Tokyo (JP)

(21) Appl. No.: 13/050,648

(22) Filed: Mar. 17, 2011

(30) Foreign Application Priority Data
Mar. 18, 2010 (JP) 2010-62435

(51) Int. Cl. B41J 13/00; B65H 5/26

(52) U.S. Cl. 400/578; 271/3.19

(57) ABSTRACT

A connection transport device (horizontal transport unit) which serves as a mediation device between an image forming device body and a post-processing device. The connection transport device comprises a first transport part for receiving a recording paper sheet on which an image is formed from a discharge part of the image forming device body and transporting the recording paper sheet to the post-processing device, a second transport part for receiving a recording paper sheet on which an image is formed from the discharge part of the image forming device body and transporting the recording paper sheet to the post-processing device, and a merging portion for stacking the recording paper sheets from the first and second transport parts and at the same time directing the recording paper sheets to the post-processing device.

### CROSS-REFERENCE TO RELATED APPLICATION

This invention is based on Japanese patent application No. 2010-62435 filed in Japan on Mar. 18, 2010, the entire content of which is hereby incorporated by reference.

### BACKGROUND OF THE INVENTION

1. Field of the Invention

The present invention relates to an image forming device such as a copying machine, a printer, a facsimile machine, or a multifunctional machine produced by combining two or more of these, particularly to an image forming device to which a post-processing device can be connected, the post-processing device being capable of subjecting a sheet-like recording medium such as recording paper sheet (hereinafter sheet-like recording medium such as recording paper sheet may be collectively referred to as “recording paper sheet” or simply as “paper sheet”.) on which an image is formed to one or more processes including a punching process, a stapling process and other post-processes.

The present invention also relates to a connection transport device serves as a mediation between an image forming device body and the post-processing device.

2. Description of Related Art

Image forming devices which can be used with a post-processing device connected thereto are conventionally known.

In an image forming device of this type, post-process speed on recording paper sheet in the post-processing device may be lower than the image formation speed in the image forming device body in some cases. In such a case, the intervals of recording paper sheets transported, in other words, image formation intervals in the image forming device body must be increased corresponding to an increase in the processing speed of the post-processing device. In such a case, the image productivity of the image forming device with the post-processing device connected thereto becomes lower as a whole relative to the original image productivity of the image forming device body.

In order to solve this problem, there has been suggested a technique that can collectively subject a stack of sheets of recording paper sheet to a post-process by transporting the stack to a post-processing device, so that the intervals of recording paper sheets transported, in other words, the image formation intervals in the image forming device body is not increased.

The technique for transporting recording paper sheet to such a post-processing device is described in Japanese Unexamined Patent Publication No. 2006-273454. According to Japanese Unexamined Patent Publication No. 2006-273454, a paper sheet transporting device which serves as a mediation is provided between the image forming device body and the post-processing device, the recording paper sheet discharged from the image forming device body is passed to the post-processing device in the form of stacks in the paper sheet transporting device.

According to the paper sheet transporting device which serves as a mediation described in Japanese Unexamined Patent Publication No. 2006-273454 (JP 2006-273454 A), a preceding paper sheet of the recording paper sheets to be stacked needs to be transported back (switched back) temporarily and be on standby in the paper sheet transporting device, and therefore an interval for allowing time to cause the preceding paper sheet to stand by in such manner is required between the preceding paper sheet and the following paper sheet, thereby reducing image productivity.

### SUMMARY OF THE INVENTION

A first object of the present invention is to provide a connection transport device serving as a mediation device between an image forming device body and a post-processing device, the image forming device body being capable of forming an image on a recording paper sheet by passing the recording paper sheet through an image forming path running through an image forming section, and discharging the recording paper sheet on which the image is formed from a discharge part, and the post-processing device being capable of performing a post-process on the recording paper sheet discharged from the discharge part of the image forming device body, the connection transport device being capable of receiving the recording paper sheet discharged from the discharge part of the image forming device body and transporting the recording paper sheet to the post-processing device, and being such that by using the connection transport device in connection between the image forming device body and the post-processing device, transport of the recording paper sheet to the post-processing device can be efficiently performed than in the case where a paper sheet transporting device which serves as a conventional mediation mentioned previously is used, and accordingly, a necessity to increase the intervals between the recording paper sheets in the image forming device body can be suppressed, a reduction in image productivity can be suppressed, and image productivity can be maintained at a high level correspondingly as a whole.

A second object of the present invention is to provide an image forming device comprising an image forming device body which is capable of forming an image on a recording paper sheet by passing the recording paper sheet through an image forming path running through an image forming section, and discharging the recording paper sheet on which the image is formed from a discharge part, and a connection transport device which receives the recording paper sheet discharged from the discharge part of the image forming device body and transports the recording paper sheet to a post-processing device which is capable of performing a post-process on the recording paper sheet, the image forming device being such that transport of the recording paper sheet can be efficiently performed to the post-processing device compared to an image forming device comprising a paper sheet transporting device which serves as a conventional mediation mentioned previously, and thereby the necessity to increase the intervals of recording paper sheets in the image forming device body can be suppressed, a reduction in image productivity can be suppressed, and image productivity can be maintained at a high level correspondingly as a whole.

In order to achieve the first object, the present invention provides a connection transport device serving as a mediation device between an image forming device body and a post-processing device, the image forming device body being capable of forming an image on a recording paper sheet by passing the recording paper sheet through an image forming path running through an image forming section, and discharging the recording paper sheet on which the image is formed from a discharge part, and the post-processing device being capable of performing a post-process on the recording paper sheet discharged from the discharge part of the image forming device body, the connection transport device being capable of receiving the recording paper sheet discharged from the discharge part of the image forming device body and transporting the recording paper sheet to the post-processing device,

the connection transport device comprising a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time.

In addition, in order to achieve the second object, the present invention provides an image forming device comprising an image forming device body which is capable of forming an image on a recording paper sheet by passing the recording paper sheet through an image forming path running through an image forming section and discharging the recording paper sheet on which the image is formed from a discharge part,

a connection transport device which receives the recording paper sheet discharged from the discharge part of the image forming device body, and transports the recording paper sheet to a post-processing device which is capable of performing a post-process on the recording paper sheet, and

a paper transport control unit which controls recording paper sheet transport in directing the recording paper sheet from the image forming device body to the post-processing device via the connection transport device,

the connection transport device comprising a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time,

the paper transport control unit being capable of executing a stack transport mode for stacking the recording paper sheets and transporting the recording paper sheets to the post-processing device, in the stack transport mode, having the first and second transport parts of the connection transport device receive the recording paper sheets from the image forming device body, having either the recording paper sheet received by the first transport part or the recording paper sheet received by the second transport part, whichever is received earlier, temporarily stand by at the first or second transport part which received the recording paper sheet, and stacking the recording paper sheets placed at the first and second transport parts at the merging portion and at the same time transporting the recording paper sheets together.

The foregoing and other objects, features, aspects and advantages of the present invention will become more apparent from the following detailed description of the preferred embodiments of the present invention when taken in conjunction with accompanying drawings.

### BRIEF DESCRIPTION OF THE DRAWINGS

FIG. 1 shows an example of the image forming device according to the present invention together with an example of a post-processing device, the image forming device employing an example of the connection transport device according to the present invention.

FIG. 2 is a block diagram which shows a control circuit of the image forming device of FIG. 1.

FIG. 3 is a flowchart which shows the operation of the control unit of the post-processing device.

FIG. 4 shows the outline of the recording paper transport path from the image forming device to the post-processing device.

FIG. 5 shows an example of transport of recording paper sheets from the image forming device body to the post-processing device when a horizontal connection transport device (horizontal transport unit) is not caused to execute the stack transport mode.

FIG. 6 shows the continuation of the transport of the recording paper sheets shown in FIG. 5, in which the first paper sheet has reached the horizontal transport unit and the second paper sheet is passing through the image forming path.

FIG. 7 shows the continuation of transport of the recording paper sheets shown in FIG. 6, in which the first paper sheet is being discharged from the post-processing device; the second paper sheet has reached the horizontal transport unit; and the third paper sheet is passing through the image forming path.

FIG. 8 shows an example of the transport of recording paper sheets from the image forming device body to the post-processing device when the horizontal connection transport device (horizontal transport unit) is caused to execute the stack transport mode.

FIG. 9 shows the continuation of the transport of recording paper sheets shown in FIG. 8.

FIG. 10 shows the continuation of the transport of recording paper sheets shown in FIG. 9.

FIG. 11 shows the continuation of the transport of recording paper sheets shown in FIG. 10.

FIG. 12 shows the continuation of the transport of recording paper sheets shown in FIG. 11.

FIG. 13 is a timing chart which shows an example of the printing order in the image forming device body.

FIG. 14 shows another example of the connection transport device (horizontal transport unit) according to the present invention and of a discharge part of an image forming device comprising the same.

### DESCRIPTION OF THE PREFERRED EMBODIMENTS

Embodiments of the present invention will be described below.

The connection transport device which is an embodiment of the present invention is as follows:

### <Connection Transport Device>

A connection transport device serving as a mediation device between an image forming device body which is capable of forming an image on a recording paper sheet by passing the recording paper sheet through an image forming path running through an image forming section and discharging the recording paper sheet on which the image is formed from a discharge part, and a post-processing device which is capable of performing a post-process on the recording paper sheet discharged from the discharge part of the image forming device body.

The connection transport device is capable of receiving the recording paper sheet discharged from the discharge part of the image forming device body, and transporting the recording paper sheet to the post-processing device.

The connection transport device comprises a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time.

The image forming device of an embodiment of the present invention is as follows:

### <Image Forming Device>

An image forming device comprising an image forming device body which is capable of forming an image on a recording paper sheet by passing the recording paper sheet through an image forming path running through an image forming section and discharging the recording paper sheet on which the image is formed from a discharge part, a connection transport device which receives the recording paper sheet discharged from the discharge part of the image forming device body, and transports the recording paper sheet to a post-processing device which is capable of performing a post-process on the recording paper sheet, and

a paper transport control unit which controls recording paper sheet transport in directing the recording paper sheet from the image forming device body to the post-processing device via the connection transport device.

The connection transport device comprises a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time.

The paper transport control unit is capable of executing a stack transport mode for stacking the recording paper sheets and transporting the recording paper sheets to the post-processing device, in the stack transport mode, having the first and second transport parts of the connection transport device receive the recording paper sheets from the image forming device body, having either the recording paper sheet received by the first transport part or the recording paper sheet received by the second transport part, whichever is received earlier, temporarily stand by at the first or second transport part which received the recording paper sheet, and stacking the recording paper sheets placed at the first and second transport parts at the merging portion and at the same time transporting the recording paper sheets together.

Herein, the term “recording paper sheet” means, as already mentioned, a sheet-like recording medium such as a paper sheet for recording.

The term “post-processing device” means a device which is capable of subjecting a recording paper sheet to one or more of the post-processes such as “folding process”, “perforation (punching) process” and “stapling process”.

Typical examples of the image forming section in the image forming device include those which is capable of forming a toner image by the electrophotographying system, transferring this onto a recording paper sheet, and fixing this on the recording paper sheet by the fixing device. When such an image forming section is employed, the image forming path is a path for passing the recording paper sheet through the image forming section and transferring a toner image onto the recording paper sheet, and fixing the image.

The image forming section may be, in addition to those mentioned above, such that is capable of forming a toner image by electrostatic recording, transferring the same onto a recording paper sheet, and fixing the same by the fixing device, and such that is capable of forming an image by the inkjet method using inks, among others.

According to the above connection transport device, the recording paper sheets discharged from the discharge part of the image forming device body can be received at both the first transport part and the second transport part. Therefore, the preceding recording paper sheet can be received at either of the transport parts; the preceding recording paper sheet received can be temporarily put on standby at the transport part; and meanwhile the next following recording paper sheet can be received by the other transport part. In such a manner, the recording paper sheets received at the first and second transport parts can be stacked at the merging portion of the first and second transport parts and efficiently directed to the post-processing device at the same time, and those recording paper sheets can be efficiently and collectively subjected to a post-process in the post-processing device.

In this manner, according to the above connection transport device, the recording paper sheets can be efficiently transported to the post-processing device by using the first and second transport parts and the merging portion of those transport parts, and therefore the intervals of recording paper sheets transported in the image forming device body need not be greatly increased (lengthened) for the stack transport, and a reduction in image productivity can be suppressed correspondingly. By extension, the image productivity can be maintained at a high level correspondingly as a whole.

The image forming device described above comprises the connection transport device mentioned above. The connection transport device can stack the recording paper sheets discharged from the discharge part of the image forming device body and efficiently direct them to the post-processing device by using the first and second transport parts and the merging portion of those transport parts, and those recording paper sheets can be efficiently and collectively subjected to a post-process in the post-processing device.

In addition, since the recording paper sheets can be efficiently transported to the post-processing device, the intervals of the recording paper sheets transported in the image forming device body need not be greatly increased (lengthened) for the stack transportation, and a reduction in image productivity can be suppressed accordingly. By extension, the image productivity of the entire image forming device can be maintained at a high level.

The number of the discharge part of the recording paper sheet of the image forming device body may be one or more.

When the number of the recording paper sheet discharge part in the image forming device body is only one, for example, a distributing member (e.g., distributing claw driven by a solenoid) which distributes the recording paper sheets to be discharged to the first or second transport part of the connection transport device may be provided on the discharge side of the recording paper sheet of the discharge part, or a distributing member (e.g., a distributing claw driven by a solenoid) for distributing the recording paper sheets to be discharged from the discharge part to the first transport part or the second transport part may be provided in the connection transport device.

Examples of the image forming device body provided with a plurality of (e.g., two) discharge parts include those which are only capable of executing a single-side mode (mode for forming images only on one side of the recording paper sheet and discharging the paper sheet).

When the image forming device body is provided with, for example, two discharge parts of recording paper sheet (first discharge part and second discharge part), the image forming device body may be so arranged as to have a switching guide portion (e.g., switching claw driven by a solenoid) for guiding the recording paper sheets discharged from the image forming path to the first discharge part or the second discharge part. In this case, the first and second transport parts of the connection transport device may be in any form as long as the former is connectable to the first discharge part and the latter to the second discharge part. In the image forming device, the connection transport device may be arranged in any way as long as the first transport part is connected to the first discharge part and the second transport part is connected to the second discharge part.

As an example of the case in which the image forming device body is provided with, for example, two discharge parts of recording paper sheet (first discharge part and second discharge part), as will be described next, one of the discharge parts may also serve as a reversing part used in a double-side image formation mode (in other words, the reversing part may also serve as one of the discharge parts).

That is, the following device can be also given as an example of the connection transport device.

In the case of the following connection transport device, the image forming device body is capable of forming an image on one side of the recording paper sheet by providing the recording paper sheet from a recording paper feed section and passing the recording paper sheet through the image forming path running through the image forming section; in a single-side mode (mode for forming an image on one side of the recording paper sheet and discharging the same), discharging the recording paper sheet on which the image is formed on the one side thereof from the discharge part; in a double-side mode (mode for forming images on both sides of the recording paper sheet and discharging the same), leading the recording paper sheet on which an image is formed on the one side thereof to the image forming path again via an reverse circulation transport path for the double-side image formation, forming an image on the other side of the recording paper sheet, and discharging the same from the discharge part.

The image forming device body comprises first and second discharge parts provided as the discharge part and a switching guide portion (e.g., switching claw driven by a solenoid) for leading the recording paper sheet from the image forming path to the first discharge part or the second discharge part.

The reverse circulation transport path comprises a reversing part which temporarily retracts the recording paper sheet which has passed through the image forming path and then transports back the recording paper sheet and a circulation transport path which receives the recording paper sheet which has been transported back from the reversing part and leads the recording paper sheet to the image forming path. The reversing part also serves as one of the first and second discharge parts.

The first transport part of the connection transport device is connectable to the first discharge part; and the second transport part of the connection transport device is connectable to the second discharge part.

In the image forming device, when the image forming device body is such a device, the first transport part is connected to the first discharge part, while the second transport part is connected to the second discharge part.

In the connection transport device and the image forming device, when the image forming device body comprises the reverse circulation transport path and can execute the double-side mode, among the first and second transport parts of the connection transport device, the transport part which receives the recording paper sheet from the discharge part which also serves as the reversing part of the reverse circulation transport path of the image forming device body may also serve as a part which receives a portion of the recording paper sheet transported from the image forming path to the reversing part during the double-side mode in the image forming device body and temporarily discharged from the reversing part.

In any case, the image forming device may comprise a paper transport control unit which controls the transport of the recording paper sheet in directing the recording paper sheet from the image forming device body to the post-processing device via the connection transport device,

the paper transport control unit being capable of executing a stack transport mode for stacking the recording paper sheets and transporting the recording paper sheets to the post-processing device, in the stack transport mode, having the first transport part and the second transport part of the connection transport device receive recording paper sheets from the image forming device body, having either the recording paper sheet received by the first transport part or the recording paper sheet received by the second transport part, whichever is received earlier, temporarily stand by at the first or second transport part which has received the recording paper sheet, and stacking the recording paper sheets placed at the first and second transport parts at the merging portion and at the same time transporting the recording paper sheets together.

In the image forming device, because of this paper sheet transport control by the paper transport control unit, the recording paper sheets can be efficiently transported in stacks to the post-processing device using the first and second transport parts and their merging portion in the connection transport device. Accordingly, the transport of the recording paper sheet intervals need not be increased (lengthened) for the stack transportation in the image forming device body, and a reduction in image productivity can be suppressed correspondingly. By extension, image productivity can be maintained at a high level correspondingly as a whole.

In the image forming device, when page numbers are printed on recording paper sheets in the image forming device body, in order to prevent a change in the order of pages in the case where the stack transport mode is employed, the image forming device body can be so arranged as to make changes in the printing order of pages when the paper transport control unit executes the stack transport mode.

In the image forming device, the post-processing device may be connected to the image forming device body via the connection transport device. In such a case, the paper transport control unit, when the image forming device body is operating in the single-side mode, may control the recording paper sheet transport in such a manner that the recording paper sheets may be transported from the image forming device body to the post-processing device by using both the first and second transport parts of the connection transport device.

The connection transport device may be an external device connectable to the image forming device body; may be attachable/detachable to the image forming device body; or may be initially provided on the image forming device body.

An example of the connection transport device and an example of the image forming device employing the same will be described below with reference to drawings.

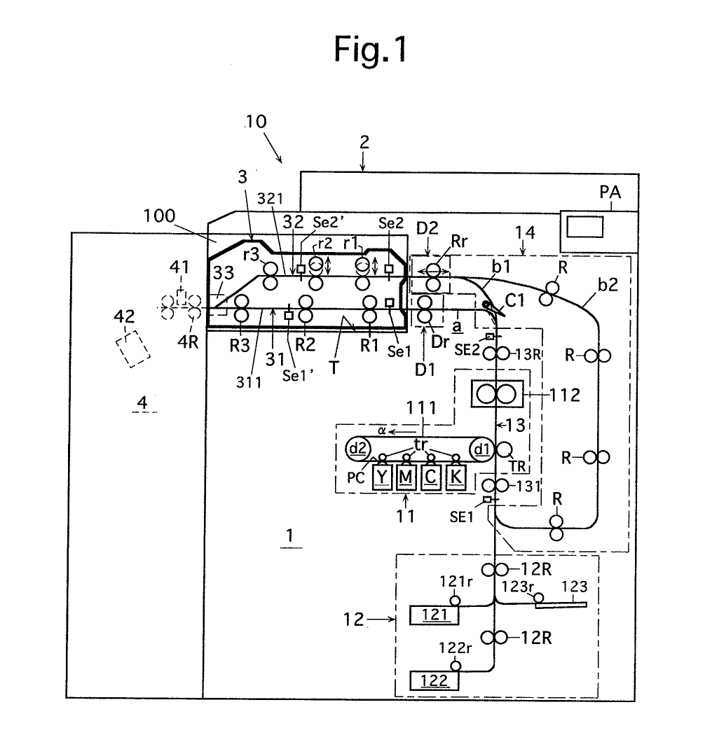

FIG. 1 shows an example of the connection transport device and an example of an image forming device employing the same, along with an example of the post-processing device.

The image forming device 10 shown in FIG. 1 comprises a body 1 of the image forming device, an image reader 2 mounted on the body 1, and a connection transport device (a horizontal connection transport device) 3. A post-processing device 4 is connected to the horizontal connection transport device 3.

This image forming device 10 is a multifunctional machine having the functions of a copying machine, printer, facsimile machine and other devices.

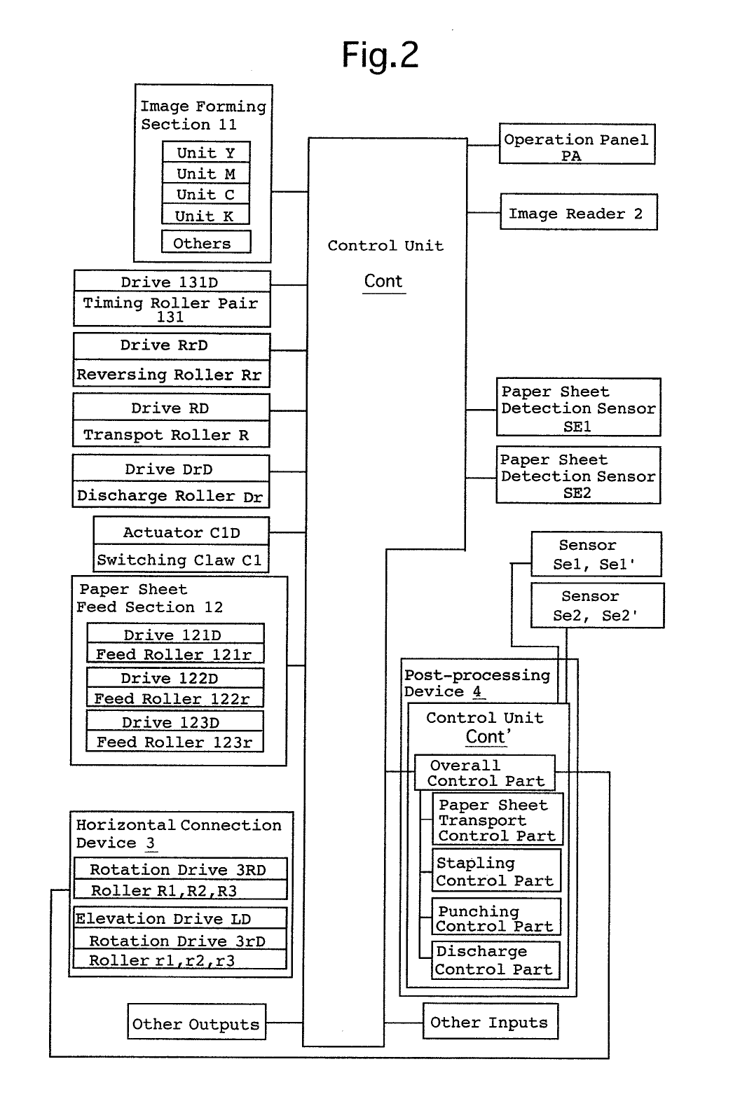

The image forming device body 1 also comprises a control unit Cont (refer to FIG. 2) which controls the operation of the image forming device 10. The components of the image forming device 10 operate by the instructions of the control unit Cont. The post-processing device 4 also comprises a control unit Cont′ which controls operations of the device 4 (refer to FIG. 2), and the components of the post-processing device 4 operate by the instructions of the control unit Cont′.

The image reader 2 per se is one which is already known, which reads an image document, and provides the read image information for copying the document, facsimile transmission and other purposes.

The horizontal connection transport device 3 is so constituted as to be attachable/detachable to the image forming device body 1. The device 3 will be described in detail later.

The post-processing device (finisher) 4 is per se a device which is already known, which is capable of executing a post-treatment mode such as a punching process and a stapling process on the recording paper sheet discharged from the image forming device body 1 with images formed thereon by the image forming device body 1. In FIG. 1, in the post-processing device 4, a component “41” is a punching device, “4R” is a registering roller before punching, and “42” is a stapling device.

The image forming device body 1 comprises an image forming section 11, a feed section 12 of the recording paper sheet (recording medium such as a sheet of recording paper) below the image forming section 11, an image forming path 13, first, second recording paper discharge parts D1, D2 which lead to the image forming path 13 and an reverse circulation transport path 14. As will be described later, the discharge part D2 also serves as a reversing part of the reverse circulation transport path 14.

The image forming section 11 comprises an intermediate transfer belt 111 which is rotationally driven by a belt driving part (not illustrated) and wound on a driving roller D1 and an opposing roller d2 so that it can be rotationally driven in a counterclockwise direction α, and a yellow image forming unit Y, a magenta image forming unit M, a cyan image forming unit C and a black image forming unit K are disposed in the order stated along the intermediate transfer belt 111 in the direction of travel of the belt.

Each of the image forming units which are assigned with color imaging, respectively, is capable of, based on image information from the image reader 2, image information transmitted from external computers (not illustrated), image information transmitted from external facsimile machines or the like, forming an electrostatic latent image corresponding to the image of the assigned color by the electrophotographying system on a photosensitive member PC, forming a toner image by developing the latent image with the toner of the assigned color, and primarily transferring this image by a primary transfer roller tr to which a primary transfer bias is applied from a power source (not illustrated) onto the belt 111.

In forming images by using the image forming units, a monochrome toner image can be formed by using one of the four image forming units, or a color image can be formed by using two or more image forming units. When two or more image forming units are used, the color toner images formed by those image forming units are primarily transferred onto the belt 111 at such timing that they are laid on top of each other on the belt 111.

The image forming section 11 further comprises a secondary transfer roller TR opposing the intermediate transfer belt 111 on the downstream side of the black image forming unit K in the direction of rotation of the intermediate transfer belt 111 and a fixing device 112 disposed thereabove.

As already described, the toner image or the toner images which are primarily transferred onto the intermediate transfer belt 111 are secondarily transferred onto the recording paper sheet transported along the image forming path 13 by the secondary transfer roller TR to which a secondary transfer bias is applied from a power source (not illustrated), and is fixed onto the recording paper sheet by the fixing device 112 under heat and pressure.

In this example, the recording paper sheet feed section 12 below the image forming section 11 comprises a feed part 121 which feeds A4-sized recording paper sheets, a feed part 122 which feeds B5-sized recording paper sheets, and a feed member (bypass tray) 123 which allows the operator to manually insert recording paper sheets.

The paper sheets in the feed parts 121, 122, 123 can be sent out to the image forming path 13 by paper feed rollers 121r, 122r, 123r, respectively. The rollers 121r, 122r, 123r can be rotationally driven by feed roller drives 121D, 122D, 123D (refer to FIG. 2), respectively.

In the recording paper sheet feed section 12, in addition to the components mentioned above, a transport roller 12R for further transporting recording paper sheets transported by the paper feed rollers 121r, 122r and 123r is disposed.

The image forming path 13 is a transport path for secondarily transferring a primarily transferred toner image on the belt 111 onto the recording paper sheet fed from the recording paper sheet feed section 12 by the secondary transfer roller TR, and transporting the recording paper sheet so that the secondarily transferred toner image is fixed by the fixing device 112, which runs through the nipping portion between the belt 111 and the secondary transfer roller TR and the fixing device 112. A paper sheet transport roller 13R is disposed on the discharge side of the fixing device 112. A transport path switching claw C1 is disposed further downstream thereof. A paper sheet detection sensor (paper discharge sensor) SE2 is disposed short of (upstream of) the switching claw C1.

The transport path of the recording paper sheet on which an image is formed by the image forming section 11 branches into two transport paths a and b1 in a portion comprising the switching claw C1. The transport path a extends to the first discharge part D1, while the transport path b1 extends to the second discharge part D2 above of the discharge part D1. The first discharge part D1 has a recording paper discharge roller Dr which can be rotationally driven in the direction of discharge of the recording paper sheet by a drive Drd (refer to FIG. 2).

The second discharge part D2 has a discharge reversing roller Rr which discharges or reverses (switches back) the recording paper sheet, and this can be forwardly (in the direction of discharge of the paper sheet) and backwardly (paper sheet reversed) rotated by a drive Rrd (refer to FIG. 2).

The switching claw C1 can be driven to swing by an actuator C1D (refer to FIG. 2) and can be in the position shown by the solid line in FIG. 1, that is, the position for guiding the recording paper sheet discharged from the roller 13R to the transport path a and the first discharge part D1, or the position shown by the broken chain line in FIG. 1, that is, the position for guiding the recording paper sheet discharged from the roller 13R to the transport path b1 and second discharge part D2, by the instructions of the control unit Cont at the timing the recording paper sheet discharged from the transport roller 13R on the image forming path 13 is detected by the sensor SE2. The switching claw C1 and its actuator C1D constitute a switching guide portion for guiding the recording paper sheet from the image forming path 13 to the first discharge part D1 or the second discharge part D2.

The recording paper sheet which is discharged from the image forming path 13 and has an image formed on one side thereof and is to be discharged as it is, or the recording paper sheet on which images are formed on both sides thereof by using the reverse circulation transport path as will be described later is guided to the first discharge part D1 or the second discharge part D2 by the switching claw C1, and is discharged to the horizontal connection transport device 3. This point will be further described later.

A timing roller pair 131 is disposed slightly upstream of the secondary transfer roller TR on the image forming path 13. The timing roller pair 131 can be rotationally driven by its drive 131D (refer to FIG. 2). The timing roller pair 131 is for temporarily stopping the recording paper sheet provided, and for transporting the recording paper sheet to the secondary transfer region at the timing the toner image on the intermediate transfer belt 111 reaches the secondary transfer region. There is the paper sheet detection sensor SE1 short of the timing roller pair 131, and the recording paper sheet is temporarily stopped when the recording paper sheet is detected by the sensor SE1 in such a manner that it can be transported again by the roller pair 131.

The reverse circulation transport path 14 includes the transport path b1 extending from the switching claw C1 portion to the second discharge part D2, and a circulation transport path b2 connected to a portion short of the discharge reversing roller Rr on the transport path b1. A paper sheet transport rollers R are disposed on the circulation transport path b2, and the rollers R can be rotationally driven by a transport roller drive RD by the instructions of the control unit Cont (refer to FIG. 2).

The reverse circulation transport path 14 is used in the following manner on the transport path used in the double-side mode for forming images on both sides of the recording paper sheet.

In the double-side mode, the transport path switching claw C1 is set in the position shown by the broken line in FIG. 1 at the timing the recording paper sheet which is transported from the image forming path 13 and on which an image is formed on one side is detected by the paper sheet detection sensor (paper discharge sensor) SE2, the recording paper sheet is guided by the claw C1 into the transport path b1, partially discharged into a transport part 32 on the upper side of the horizontal connection transport device 3 described later by the forwardly driven discharge reversing roller Rr.

The roller Rr is then started to be backwardly rotated (reversed) immediately before the rear end of the recording paper sheet passes the roller Rr. Accordingly, the recording paper sheet is switched back, loaded onto the circulation transport path b2 with the aid of the elastically restoring ability of the paper sheet, enters the image forming path 13 again via the circulation transport path b2, is detected by the paper sheet detection sensor SE1 there, and is temporarily stopped by the timing roller pair 131. The recording paper sheet is then fed to the secondary transfer region by the timing roller pair 131 at the timing a toner image for the back side of the recording paper sheet on the intermediate transfer belt 111 arrives the secondary transfer region, and is further passed through the fixing device 112. Thus, images are formed on both sides of the recording paper sheet, and transported to the first discharge part D1 or second discharge part D2.

The horizontal connection transport device (hereinafter it also may be referred to as “horizontal transport unit”.) 3 comprises a first transport part 31 for receiving the recording paper sheet from the first (lower) discharge part D1 of the image forming device body 1 and transporting the recording paper sheet to the post-processing device 4, the aforementioned second transport part 32 for receiving the recording paper sheet from the second (upper) discharge part D2 of the image forming device body 1 and transporting the recording paper sheet to the post-processing device 4, and a merging portion 33 for stacking the recording paper sheets from the first and second transport parts 31, 32 and directing the recording paper sheets to the post-processing device at the same time.

The first transport part 31 comprises a horizontal transport path 311 and recording paper transport rollers R1, R2, R3 disposed along the transport path 311, and the recording paper transport rollers R1, R2, R3 can be rotationally driven by a rotation drive 3RD in the direction of discharge of the paper sheet (refer to FIGS. 1 and 2 for the above) by the instructions of the control unit Cont′ (refer to FIG. 2) of the post-processing device 4 described later.

The second transport part 32 comprises a recording paper transport path 321 extending horizontally and then running into the lower transport path 31, and recording paper transport rollers r1, r2, r3 disposed along the transport path 321. The recording paper transport rollers r1, r2, r3 can be rotationally driven by the rotation drive 3rD in the direction of discharge of the paper sheet by the instructions of the control unit Cont′ of the post-processing device 4 described later (refer to FIG. 2). The upper roller parts constituting the rollers r1, r2 on the entrance side of the device 3 can be spaced apart upwardly from the transport path 321 by an elevation drive LD, and can be also lowered to the position of transport of the paper sheet (refer to FIGS. 1 and 2 for the above)

The transport paths 311, 321 are merged at the merging portion 33, extending to a paper sheet loading port of the post-processing device 4. The upper transport path 321 is longer than the lower transport path 311.

A paper sheet loading detection sensor Se1 which detects the loading of paper sheets onto the first transport part 31 is provided slightly upstream of the recording paper transport roller R1 in the transport path 31, and an intermediate paper sheet detection sensor Se1′ is disposed between the recording paper transport rollers R2 and R3.

The paper sheet loading detection sensor Se2 which detects the loading of the paper sheet onto the transport part 32 is provided slightly upstream of the recording paper transport roller r1 in the second transport part 32, and intermediate paper sheet detection sensor Se2′ is disposed between the recording paper transport rollers r2 and r3. The paper sheet detection sensors Se1, Se1′, Se2, Se2′ are mainly used for detecting paper jams and measuring the timings of the start/stop of driving of the recording paper transport rollers.

The upper transport path 321 of the horizontal transport unit 3 can function as a portion for receiving the portion of the recording paper sheet discharged from the image forming device body 1 during the double-side mode mentioned previously, when a part of the recording paper sheet is temporarily discharged to the outside of the image forming device body 1 by the discharge reversing roller Rr of the discharge part (reversing part) D2, by retracting the upper roller parts of the recording paper transport rollers r1, r2 upwardly.

The horizontal transport unit 3 is inserted and mounted on a mount portion 100 formed in the image forming device body 1. The first transport part 31 is connected to the first discharge part D1 of the image forming device body 1, while the second transport part 32 is connected to the second discharge part D2 of the image forming device body 1. The horizontal transport unit 3 is attachable to and detachable from the image forming device body 1, and can be removed from the state of being attached to the image forming device body 1 as shown in FIG. 1. If the post-processing device 4 is not used, it may be removed. The portion of the image forming device body 1 with the horizontal transport unit 3 removed off from the same can be used as a discharge tray T for receiving the recording paper sheet discharged from the discharge part D1 or D2.

FIG. 4 schematically shows the recording paper transport paths described above.

FIG. 2 is a block diagram which shows the outline of the control circuit of the image forming device 10 shown in FIG. 1. As shown in FIG. 2, the control circuit of the image forming device 10 comprises a computer-assisted control unit Cont which controls the operation of the image forming device 10. Including the image forming section 11 in the image forming device body 1, the drives, actuators and other components operable are operated by the instructions of the control unit Cont. The paper detection information by the paper sheet detection sensors SE1, SE2 is input to the control unit Cont.

The image reader 2 and the operational panel PA are connected to the control unit Cont, and the image reader 2 and the operational panel PA can operate by the instructions of controlling parts (not illustrated) for the image reader 2 and the operational panel PA included in the control unit Cont. The controlling parts control the image reader 2 and the operational panel PA, respectively while communicating with the whole of the control unit Cont.

The post-processing device 4 is also connected to the control unit Cont. The post-processing device 4 comprises a computer-assisted control unit Cont′ for the post-processing device. The control unit Cont′ has a part for overall control, and control of paper sheet transport, control of stapling processes, control of punching processes, and control of discharge of the recording paper sheets to the outside of the post-processing device are conducted by the instructions of the part for overall control.

The operational panel PA for the operator is provided with keys for selecting the size of the recording paper sheet used for image formation, number keys for setting the number of sheets of image formation, as well as keys for selecting the following modes, among others:

(1) Single-side image formation mode (single-side mode) or double-side image formation mode (double-side mode)
(2) Post-process mode [punching process, stapling process by a stapler, etc.] desired in the post-processing device 4, etc.

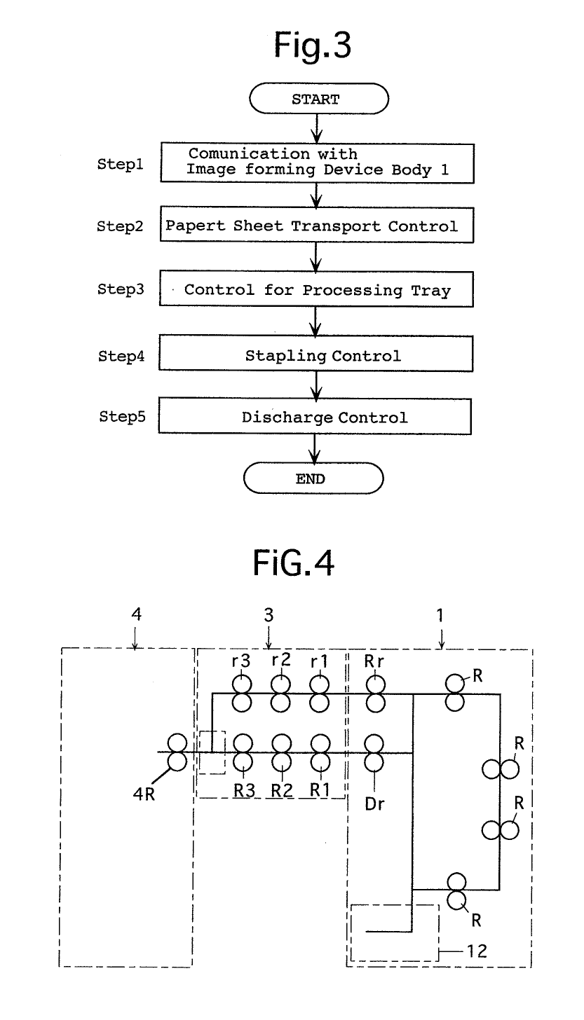

FIG. 3 is a flowchart which shows an example of the operation of the control unit Cont′ of the post-processing device 4. The flowchart in FIG. 3 is an example of the case in which a stapling process is selected as the post-treatment mode on the operational panel PA.

As shown in FIG. 3, when the program is started, the control unit Cont′ of the post-processing device 4 communicates with the control unit Cont for the image forming device 10 (step 1), and then controls paper sheet transport in the horizontal transport unit 3 (step 2), controls the loading of paper sheets into a processing tray in the post-processing device (step 3), controls stapling (step 4) and controls discharging of recording papers (step 5) sequentially.

In the communication with the control unit Cont on the image forming device body side, the control unit Cont′ receives the information of each recording paper sheet, e.g., the size, transmitted from the control unit Cont for transporting the recording paper sheet on which an image is formed from the body 1 to the post-processing device 4 via the horizontal transport unit 3, judges whether or not to accept the recording paper sheets in the form of a stack, in other words, judges whether or not to have the horizontal transport unit 3 execute the stack transport mode, and transmits the judgment result to the control unit Cont.

Such stack mode in the horizontal transport unit 3 is for increasing the post-process efficiency by subjecting the recording paper sheets in the form of a stack to a post-process in the post-processing device 4, and thus suppressing lengthening of the intervals between recording paper sheets (in other words, image formation intervals) in the image forming device body 1, and preventing lowered image productivity for the post-process. Depending on the recording paper sheet discharged from the image forming device body 1, the image formation mode of the body 1 and other conditions, there are some cases in which the post-process can be efficiently executed without employing the stack transport mode or the post-process can be conducted more efficiently by employing the stack transport mode (e.g., the case in which the post-process speed of the post-processing device 4 is lower than the image formation speed of the image forming device body 1, and therefore higher efficiency is achieved by employing the stack transport mode). Therefore, which mode is more efficient is judged case by case.

In this example, the transport of the paper sheet by the horizontal transport unit 3 is controlled by the control unit Cont′ of the post-processing device 4, and therefore the paper detection information by the paper sheet detection sensors Se1, Se1′, Se2, Se2′ in the horizontal transport unit 3 is input to the control unit Cont′ of the post-processing device 4.

When the control unit Cont of the image forming device 10 receives a judgment result from the post-processing device 4 that it is not necessary to have the horizontal transport unit 3 execute the stack transport mode, the recording paper sheet is discharged from the first discharge part D1. The horizontal transport unit 3 receives the recording paper sheet discharged by the discharge roller Dr of the discharge part D1 of the body 1 at the lower first transport part 31, and transfers the recording paper sheet to the post-processing device 4 sequentially.

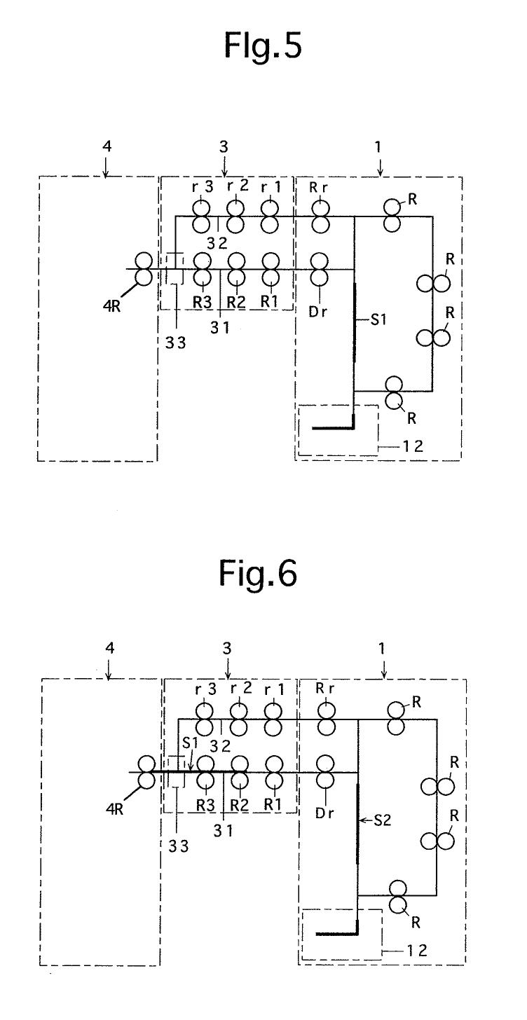

FIGS. 5, 6 and 7 show examples of the transport of the recording paper sheets.

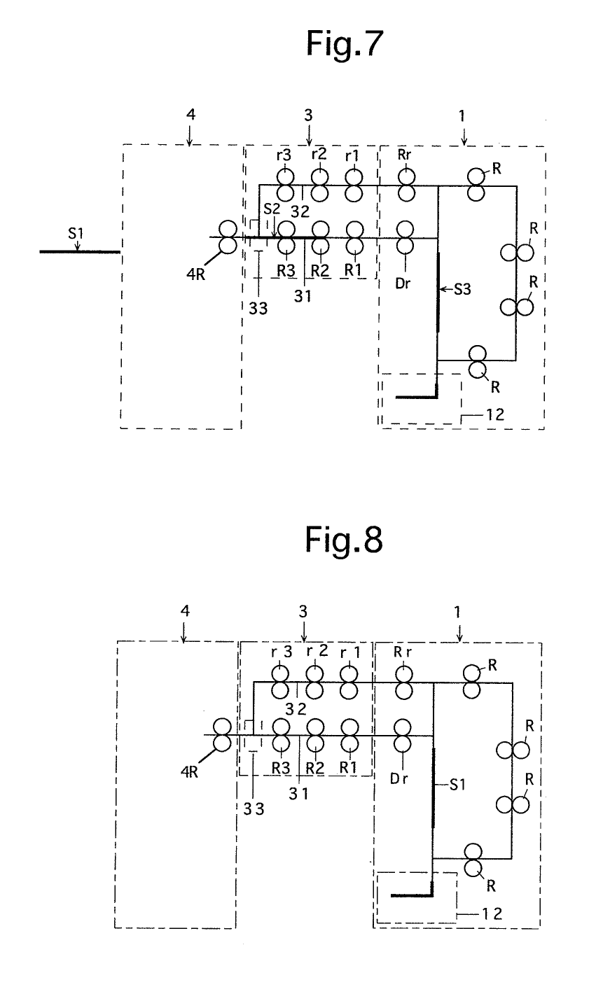

FIG. 5 shows an example of the transport of the recording paper sheets from the image forming device body 1 to the post-processing device 4 when the recording paper sheets are discharged via the post-processing device 4, with no post-process performed in the post-processing device 4 and with the horizontal connection transport device (horizontal transport unit) 3 not executing the stack transport mode. FIG. 6 shows the continuation of the transport of the recording paper sheets shown in FIG. 5, in which a first paper sheet S1 is in the horizontal transport part 31 and has reached the regist roller 4R, while a second paper sheet S2 is passing through the image forming path 13. FIG. 7 shows the continuation of the transport of the recording paper sheets following FIG. 6, in which the first paper sheet S1 has been discharged from the post-processing device 4; the second paper sheet S2 is in the horizontal transport part 31; and the third paper sheet S3 is passing through the image forming path 13.

When the control unit Cont of the image forming device 10 receives a judgment result from the post-processing device 4 that it is necessary to have the horizontal transport unit 3 execute the stack transport mode, the recording paper sheets are discharged using not only the first discharge part D1 but also the second discharge part D2 (with the roller Rr caused to rotate for paper sheet discharge).

At this time, the horizontal transport unit 3 is controlled by the paper transport control unit in the control unit Cont′ of the post-processing device 4, and the recording paper sheets discharged from the first discharge part D1 is received at the first transport part 31 and transported to the post-processing device 4. The recording paper sheets discharged from the second discharge part D2 is received at the second transport part 32 and transported to the post-processing device 4.

In this example, the horizontal transport unit 3 receives the recording paper sheet with the higher page number of two recording paper sheets to be stacked in the horizontal transport unit 3, at the second transport part 32 to temporarily stop the sheet, while it receives the recording paper sheet with the lower page number at the first transport part 31 during this while. In addition, the recording paper sheets accepted at the first, second transport parts 31, 32 are stacked at the merging portion 33 and are transported to the post-processing device 4 at the same time. This is for preventing the reversal of the order of the two recording paper sheets.

In the post-processing device 4, the recording paper sheet stack transported in such a manner is accepted on the processing tray (step 3); subjected to a stapling process (step 4); and discharged (step 5).

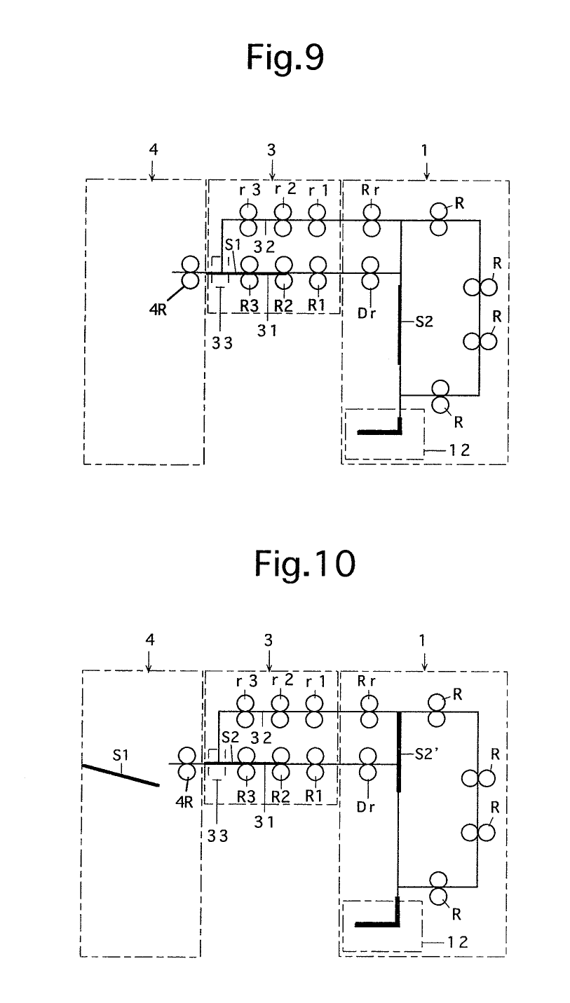

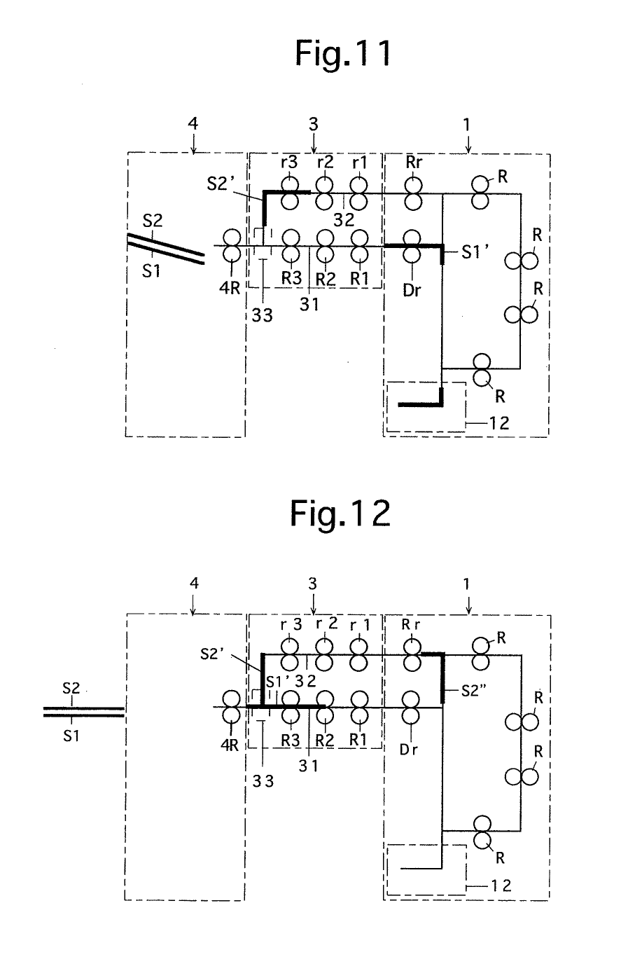

FIGS. 8 to 12 show examples of the transport of the recording paper sheets when a single set of recording paper sheets is constituted by two sheets.

The first and second sheets in the first set, i.e., recording paper sheets S1, S2, discharged from the image forming device body 1 can be stacked on the tray in the post-processing device 4 and stapled.

However, if the paper sheets in the second and subsequent sets are loaded into the post-processing device 4 not in stacks but sheet by sheet like the first set, the following paper sheet may be loaded into the post-processing device while the preceding paper sheet is still in the post-process so that a normal post-process may not be performed. Increasing the intervals between recording paper sheets in the image forming device body 1 for the purpose of solving this problem lowers image productivity. FIGS. 8 to 12 shows an instance of an improved example of transportation of the recording paper sheets.

As shown in FIGS. 8 to 12, the first and second sheets in the first set, i.e., the recording paper sheets S1, S2, are sequentially discharged from the first discharge part D1, sequentially loaded into the post-processing device 4 via the first transport part 31 of the horizontal transport unit 3, stacked in the post-processing device, stapled and discharged.

However, the recording paper sheets S1′, S2′, S2″ and other sheets in the second and subsequent sets are, as shown in FIGS. 10 to 12, transported to the post-processing device 4 via the horizontal transport unit 3 in the stack transport mode, and are stapled there. Herein S2″ denotes the second page in the third set.

The first two recording paper sheets S1, S2 may be, as in the cases shown in FIGS. 5 to 7, printed in the order of the page number in the image forming device body 1, sequentially discharged, transported past the horizontal transport unit 3, and loaded into the post-processing device 4.

However, as for the recording paper sheets S1′, S2′, S2″ and other sheets in the second and subsequent sets, images are formed first on the recording paper sheet S2′ with the higher page number in the two recording paper sheet (e.g., S1′ and S2′) to be stacked in the horizontal transport unit 3, which is then accepted in the second transport part 32, and is temporarily stopped when it reaches the regist roller 4R of the post-processing device 4 in this example. Meanwhile, an image is formed on the recording paper sheet S1′ with the lower page number, which is then accepted in the first transport part 31. When the front end the recording paper sheet S2′ of the second transport part 32 and the front end of the recording paper sheet S1′ of the first transport part 31 are aligned, the recording paper sheets S2′ and S1′ are stacked at the merging portion 33 and simultaneously loaded into the post-processing device 4. Since the first paper sheet S2″ in the next set is caused to wait in the horizontal transport unit 3, the paper sheet S2″ is prevented from overlapping the paper sheets S1′, S2′ in the second set during the post-process.

It should be noted that the following page, i.e., the recording paper sheet S2″ and the like is subjected to image formation and passed through the second transport part 32 earlier for the purpose of preventing the reversal of the order of pages in discharging, and for facilitating the transport of the recording paper sheet to the stop position after the preceding paper sheet has been discharged by passing the recording paper sheet through the second transport part 32 with a long path length.

As already mentioned, when the stack transport mode is executed in the horizontal transport unit 3, the printing order of pages in the sets in the image forming device body 1 is changed by the instructions of the control unit Cont.

For example as in the case shown in FIG. 1, when the post-processing device 4 is connected to the image forming device body 1 via the horizontal transport unit 3 and the image forming device body 1 performs image formation in the single-side mode, the recording paper sheets from the image forming device body 1 may be transported to the post-processing device 4 by using both the first and second transport parts 31, 32 of the horizontal transport unit 3. That is, when the single-side mode is employed and the post-process is performed by using the post-processing device 4, the stack transportation may be unconditionally performed to improve productivity.

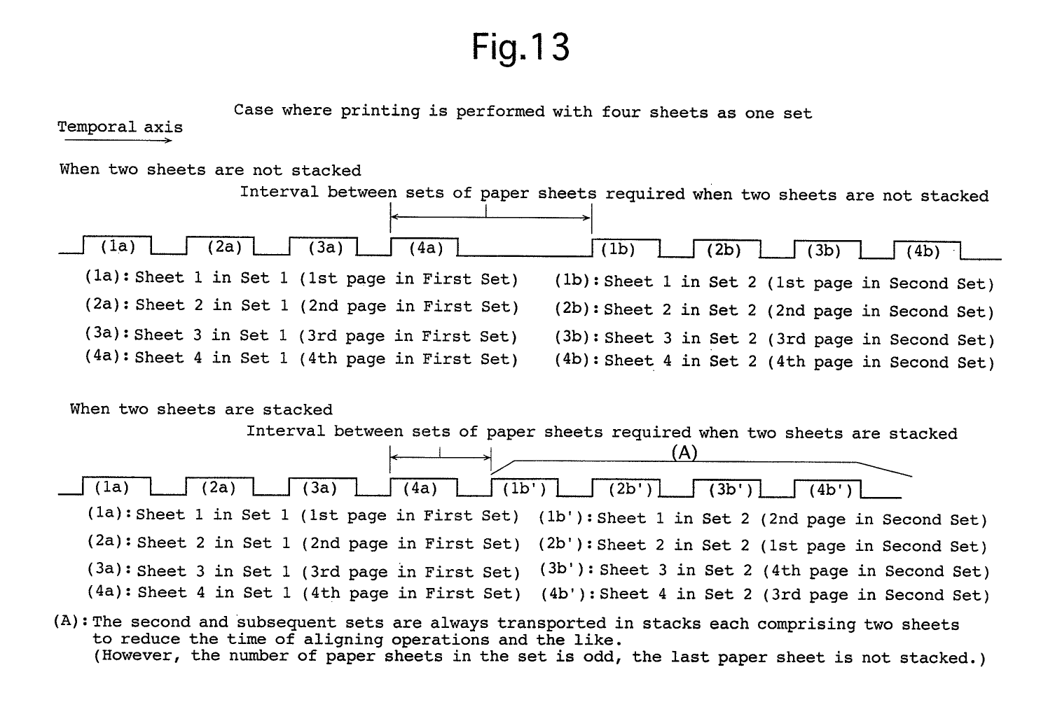

FIG. 13 is a timing chart which shows the printing orders in the case in which printing is conducted with four paper sheets as a set, where two-sheet stack transport mode is and is not employed.

Needless to say, even when the two-sheet stack transport mode is employed, in the case where the last paper sheet is an odd-numbered sheet, the stack transport mode is not employed for the paper sheet.

When the post-process is performed in the post-processing device 4 and the paper sheet is transported sheet by sheet, as shown in the upper half of FIG. 13, the interval between the last paper sheet in a set and the first paper sheet in the next set needs to be sufficient for performing the post-process. Therefore, it may be greater than a usual paper interval.

In such a case, the two-sheet stack transportation is performed, whereby the first paper in the set next to the one which is being subjected to the post-process is caused to stand by in the horizontal transport unit 3 and transported in a stack with the second sheet. Therefore, the paper intervals are not increased compared to the case where the paper sheets are transported sheet by sheet. The image productivity can be maintained at a high level correspondingly.

In addition, when the two-sheet stack is conducted in this example, even-numbered paper sheets in a set pass through the discharge reversing roller Rr and the upper transport part 32 in the horizontal transport unit 3. Therefore, even-numbered pages are printed on odd-numbered paper sheets, and odd-numbered pages are printed on even-numbered paper sheets so that the order of pages in the set is not changed.

According to the image forming device 10 and the post-processing device 4, the stack transport mode can be employed in the horizontal transport unit 3; the processing efficiency of the post-processing device 4 can be improved by employing the stack transport mode, whereby the productivity of the image forming device 10 can be maintained at a high level; the processing speed of the post-processing device 4 can be moderate correspondingly; the quietness is improved accordingly; the constitution of the post-processing device can be compact; and an increase in the costs can be advantageously suppressed.

In the examples described above, the control of the transport of the recording paper sheet from the image forming device body 1 to the post-processing device 4 via the horizontal transport unit 3 is conducted by the convertible use of the discharge parts D1, D2 by the control unit Cont of the image forming device 10 and by the control of the horizontal transport unit 3 by the control unit Cont′ of the post-processing device 4 (in particular its sheet transport control part). But the part which controls the transport of the paper sheet at the horizontal transport unit 3 may be in the control unit Cont of the image forming device 10. In addition, in the example described above, whether or not the paper sheet transport mode in the horizontal transport unit 3 is the stack transport mode is transmitted from the post-processing device 4 to the control unit Cont, but whether or not the paper sheet transport mode in the horizontal transport unit 3 is the stack transport mode may be for example, rendered selectable on the operational panel PA on the image forming device in such a case that the performance and other conditions of the post-processing device 4 is known in advance. In other words, the control of the transport of paper sheets including that of the horizontal transport unit 3 from the image forming device body 1 to the post-processing device 4 via the horizontal transport unit 3 may be controlled by a paper transport control unit which is capable of efficiently performing the post-process in the post-processing device 4, and thereby maintaining the image productivity in the image forming device 10 at a high level.

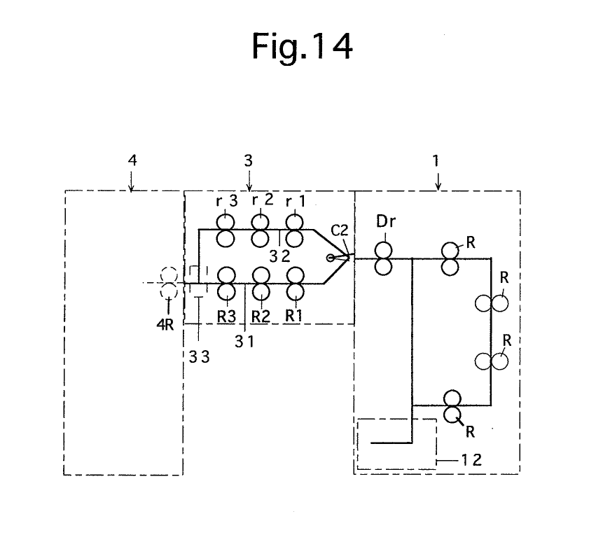

In addition, although the image forming device body 1 described above comprises two discharge parts D1 and D2 as discharge part, for example, as shown in FIG. 14, the image forming device body 1 may employ only a single discharge part having the discharge roller Dr as the discharge part. In this case, the horizontal transport unit 3 may be so constituted, for example, as to comprise a component such as a switching guide portion (switching claw in the example illustrated) C2 which can switchably guide the recording paper sheet discharged from the discharge roller Dr to the first transport part 31 or the second transport part 32.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A connection transport device serving as a mediation device between an image forming device body and a post-processing device, the image forming device body being capable of forming an image on a recording paper sheet by passing the recording paper sheet through an image forming path running through an image forming section, and discharging the recording paper sheet on which the image is formed from a discharge part, and the post-processing device being capable of performing a post-process on the recording paper sheet discharged from the discharge part of the image forming device body, the connection transport device being capable of receiving the recording paper sheet discharged from the discharge part of the image forming device body, and transporting the recording paper sheet to the post-processing device,
the connection transport device comprising a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time.

2. The connection transport device according to claim 1, wherein the image forming device body comprises first and second discharge parts as the discharge part of the recording paper sheet and a switching guide portion for leading the recording paper sheet from the image forming path to the first discharge part or the second discharge part; the first transport part is connectable to the first discharge part; and the second transport part is connectable to the second discharge part.

3. The connection transport device according to claim 1, wherein the image forming device body is capable of forming an image on one side of the recording paper sheet by providing the recording paper sheet from a recording paper sheet feed section and passing the recording paper sheet through the image forming path running through the image forming section, in a single-side mode, discharging the recording paper sheet on which the image is formed on the one side thereof from the discharge part, in a double-side mode, leading the recording paper sheet on which the image is formed on the one side thereof to the image forming path again via an reverse circulation transport path for double-side image formation, forming an image on the other side of the recording paper sheet and discharging the recording paper sheet from the discharge part; the image forming device body comprises first and second discharge parts provided as the discharge part and a switching guide portion for leading the recording paper sheet from the image forming path to the first discharge part or the second discharge part; the reverse circulation transport path comprises a reversing part which temporarily retracts the recording paper sheet which has passed through the image forming path and then transports back the recording paper sheet and a circulation transport path which receives the recording paper sheet which has been transported back from the reversing part and leads the recording paper sheet to the image forming path; the reversing part also serves as one of the first and second discharge parts;
the first transport part is connectable to the first discharge part; and the second transport part is connectable to the second discharge part.

4. The connection transport device according to claim 3, wherein in the first and second transport parts, the transport part which receives the recording paper sheet from the discharge part which also serves as the reversing part of the reverse circulation transport path of the image forming device body also serves as a part for receiving a portion of the recording paper sheet which is transported from the image forming path to the reversing part and temporarily discharged from the reversing part during the double-side mode in the image forming device.

5. An image forming device comprising an image forming device body which is capable of forming an image on a recording paper sheet by passing the recording paper sheet through an image forming path running through an image forming section and discharging the recording paper sheet on which the image is formed from a discharge part,
a connection transport device which receives the recording paper sheet discharged from the discharge part of the image forming device body, and transports the recording paper sheet to a post-processing device which is capable of performing a post-process on the recording paper sheet, and
a paper transport control unit which controls recording paper sheet transport in directing the recording paper sheet from the image forming device body to the post-processing device via the connection transport device,
the connection transport device comprising a first transport part for receiving the recording paper sheet from the discharge part of the image forming device body and transporting the recording paper sheet to the post-processing device, a second transport part for receiving the recording paper sheet from the discharge part of the image forming device body and transporting the recording paper sheet to the post-processing device, and a merging portion for stacking the recording paper sheets from the first and second transport parts and directing the recording paper sheets to the post-processing device at the same time,
the paper transport control unit being capable of executing a stack transport mode for stacking the recording paper sheets and transporting the recording paper sheets to the post-processing device, in the stack transport mode, having the first and second transport parts of the connection transport device receive the recording paper sheets from the image forming device body, having either the recording paper sheet received by the first transport part or the recording paper sheet received by the second transport part, whichever is received earlier, temporarily stand by at the first or second transport part which received the recording paper sheet, and stacking the recording paper sheets placed at the first and second transport parts at the merging portion and at the same time transporting the recording paper sheets together.

6. The image forming device according to claim 5, wherein the image forming device body comprises first and second discharge parts as the discharge part of the recording paper sheet and comprises a switching guide portion for leading the recording paper sheet from the image forming path to the first discharge part or the second discharge part, the first transport part of the connection transport device is connected to the first discharge part, and the second transport part of the connection transport device is connected to the second discharge part.

7. An image forming device according to claim 5, wherein the image forming device body is capable of forming an image on one side of the recording paper sheet by providing the recording paper sheet from a recording paper sheet feed section and passing the recording paper sheet through the image forming path running through the image forming section, in a single-side mode, discharging the recording paper sheet on which the image is formed on the one side thereof from the discharge part, in a double-side mode, leading the recording paper sheet on which the image is formed on the one side thereof to the image forming path again via an reverse circulation transport path for double-side image formation, forming an image on the other side of the recording paper sheet and discharging the recording paper sheet from the discharge part; the image forming device body comprises first and second discharge parts provided as the discharge part and a switching guide portion for leading the recording paper sheet from the image forming path to the first discharge part or the second discharge part; the reverse circulation transport path comprises a reversing part which temporarily retracts the recording paper sheet which has passed through the image forming path and then transports back the recording paper sheet and a circulation transport path which receives the recording paper sheet which has been transported back from the reversing part and leads the recording paper sheet to the image forming path; the reversing part also serves as one of the first and second discharge parts;
the first transport part of the connection transport device is connected to the first discharge part; and the second transport part of the connection transport device is connected to the second discharge part.

8. An image forming device according to claim 7, wherein the reversing part in the reverse circulation transport path in the image forming device body also serves as the second discharge part, and the second transport part of the connection transport device also serves as a part which receives a portion of the recording paper sheet transported from the image forming path to the reversing part and temporarily discharged from the reversing part during the double-side mode in the image forming device body.

9. An image forming device according to claim 5, wherein the image forming device body changes printing order of pages in a set when the paper transport control unit executes the stack transport mode.

10. The image forming device according to claim 5, wherein the post-processing device is connected to the image forming device body via the connection transport device, and the paper transport control unit transports the recording paper sheet from the image forming device body to the post-processing device by using both the first and second transport parts of the connection transport device when the image forming device body is in the single-side mode.
